(19) United States
(12) Patent Application Publication
(10) Pub. No.: US 2015/0278178 A1
(43) Pub. Date: Oct. 1, 2015

(54) INFORMATION INTEGRATION APPARATUS, INFORMATION INTEGRATION SYSTEM AND NON-TRANSITORY COMPUTER READABLE RECORDING MEDIUM

(71) Applicants: DENSO CORPORATION, Kariya-city (JP); Tokyo Women's Medical University, Tokyo (JP)

(72) Inventors: Hideki OKUDA, Nagoya (JP); Hajime SASAKI, Obu-shi (JP); Minoru TAKAHASHI, Tokoname-shi (JP); Jun OKAMOTO, Tokyo (JP); Yoshihiro MURAGAKI, Tokyo (JP)

(21) Appl. No.: 14/667,886

(22) Filed: Mar. 25, 2015

(30) Foreign Application Priority Data
Mar. 26, 2014 (JP) 2014-063716

(51) Int. Cl. G06F 17/24; G06F 17/21; G06F 17/30

(52) U.S. Cl. CPC G06F 17/24; G06F 17/30353; G06F 17/211

(57) ABSTRACT

An information integration apparatus includes: an information acquiring means for acquiring a plurality of pieces of information from at least one device; a time tag inserting means for inserting a time tag, which indicates time when the information is acquired, in the information; a type tag inserting means for inserting a type tag, which indicates a type of the information, in the information; an information storing means for storing the information, in which the time tag and the type tag are inserted, to a storage unit; an information reading means for setting a time point and reading the information, which has the latest time tag indicative of time before the time point, for each type of the information, from the storage unit; and an information outputting means for outputting the read information to display the information by a display unit using a display method suited to the type of information.

### CROSS-REFERENCE TO RELATED APPLICATION

This application is based on and claims the benefit of priority from earlier Japanese Patent Application No. 2014-063716 filed Mar. 26, 2014, the description of which is incorporated herein by reference.

### BACKGROUND

1. Technical Field

The present invention relates to an information integration apparatus, an information integration system, and a non-transitory computer readable recording medium.

2. Related Art

In medical field of conventional art, there is known a medical information system which retrieves a plurality of types of information, integrates the plurality of types of information, and displays the integrated information (see JP-T-2011-501273).

When a plurality of types of information are integrated and displayed, the following processes are considered to be performed. Specifically, each of the plurality of types of information is periodically acquired and sequentially stored. Then, the latest piece of information is selected, on an information-type basis, from among the pieces of information as acquired, and the selected pieces of information are integrated and displayed.

The time of acquiring the latest piece of information may be different to a great extent, depending on the types of information. In such a case, the processes as mentioned above may result in displaying integrated pieces of information, which are different from each other to a great extent in their acquisition time.

### SUMMARY

An embodiment provides an information integration apparatus, an information integration system, and a non-transitory computer readable recording medium, which are able to solve the problem mentioned above.

As an aspect of the embodiment, an information integration apparatus is provided which includes: an information acquiring means for acquiring a plurality of pieces of information from at least one device; a time tag inserting means for inserting a time tag, which indicates time when the information acquiring means acquires the information, in the information; a type tag inserting means for inserting a type tag, which indicates a type of the information, in the information; an information storing means for storing the information, in which the time tag and the type tag are inserted, to an information storage unit; an information reading means for setting a time point and reading the information, which has the latest time tag indicative of time before the time point, for each type of the information, from the information storage unit; and an information outputting means for outputting the information read by the information reading means to display the information by an image display unit using a display method suited to the type of information.

### BRIEF DESCRIPTION OF THE DRAWINGS

In the accompanying drawings:

FIG. 1 is a block diagram illustrating a configuration of an information integration apparatus;

FIG. 2 is a flow diagram illustrating an information storage process performed by the information integration apparatus;

FIG. 3 is a flow diagram illustrating an information type determination process performed by the information integration apparatus;

FIG. 4 is a flow diagram illustrating an information display process performed by the information integration apparatus;

FIG. 5 is an explanatory diagram illustrating information that is read in the information display process;

FIGS. 6A and 6B are explanatory diagrams each illustrating an example of a layout;

FIG. 7 is a flow diagram illustrating a layout setting process performed by the information integration apparatus;

FIG. 8 is a flow diagram illustrating an information display process performed by an information integration apparatus; and

FIG. 9 is a block diagram illustrating a configuration of an information integration system.

### DETAILED DESCRIPTION OF THE PREFERRED EMBODIMENTS

With reference to the accompanying drawings, hereinafter are described some embodiments of the present invention. It should be noted that, in the second and the subsequent embodiments, the components identical with or similar to those in the first embodiment are given the same reference numerals for the sake of omitting unnecessary explanation.

### First Embodiment

### 1. Configuration of Information Integration Apparatus 1

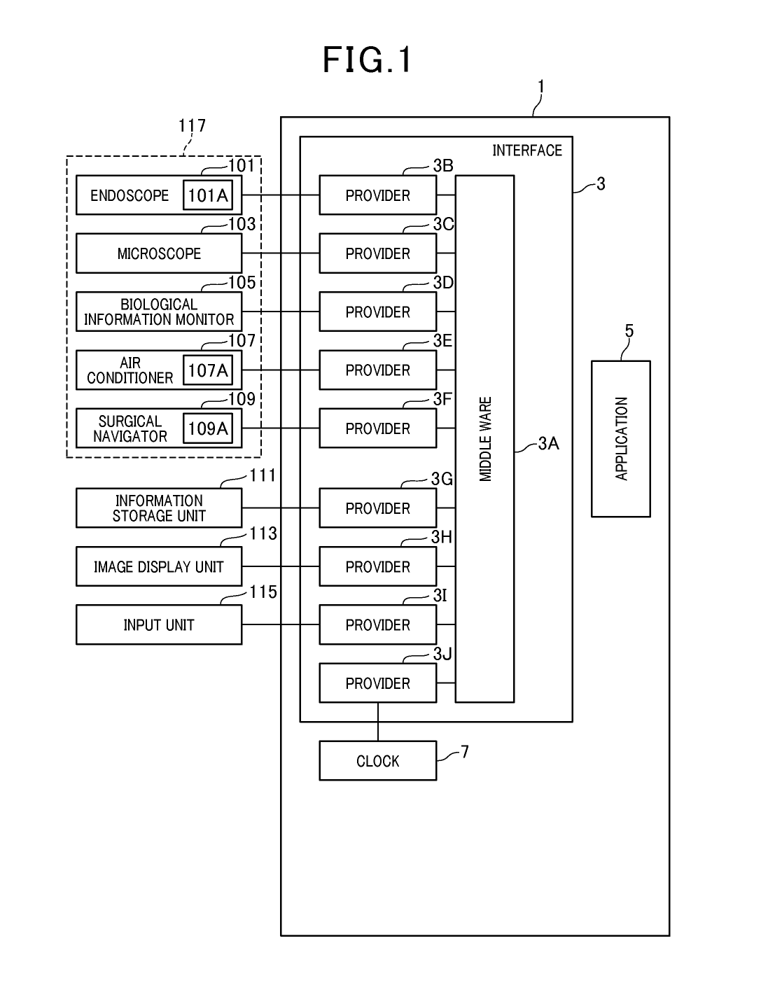

Referring to FIG. 1, the configuration of an information integration apparatus 1 according to the first embodiment is described. FIG. 1 is a block diagram illustrating the configuration of the information integration apparatus. The information integration apparatus 1 integrates various types of information in an operating room, and stores and displays the various types of information. The information integration apparatus 1 is a well-known computer that includes a CPU, a RAM and a HDD (hard disk drive) (non-transitory computer readable recording medium). The information integration apparatus 1 performs processes, which will be described later, according to a program installed (recorded) in the HDD (hard disk drive). Functionally, the information integration apparatus 1 includes an interface 3, an application 5, and a clock 7.

The interface 3 relays information transmission/reception between an external endoscope 101, a microscope 103, a biological information monitor 105, an air conditioner 107, a surgical navigator (navigation system) 109, an information storage unit 111, an image display unit 113, an input unit 115, and the like. In the following description, the endoscope 101, the microscope 103, the biological information monitor 105, the air conditioner 107 and the surgical navigator 109 may also be collectively referred to as a device group 117. Further, any one of the endoscope 101, the microscope 103, the biological information monitor 105, the air conditioner 107 and the surgical navigator 109 may also be referred to as a device.

The interface 3 is configured by middleware 3A, and providers 3B to 33. The middleware 3A is ORiN. The interface 3 enables information transmission/reception between the device group 117, the information storage unit 111, the image display unit 113 and the input unit 115, irrespective of the programming language and the type of communication protocol. There is no particular limitation in the method of connecting the interface 3 to a device, the information storage unit 111, the image display unit 113 and the input unit 115. For example, such a method can include LAN (local area network), HD-SDI (hard drive serial digital interface), a controller, or a LAN option connector.

The application 5 uses information resulting from transmitting information from the interface 3 to the device group 117, the information storage unit 111, the image display unit 113 and the input unit 115, or vice versa, to perform the processes which will be described later. The clock 7 generates real-time (clock time) information and outputs the time information to the provider 33. As will be described later, the clock 7 is used as a basis in setting a time point S.

The endoscope 101, the microscope 103, the biological information monitor 105, the air conditioner 107, and the surgical navigator 109 each output information to the information integration apparatus 1. The information outputted from the endoscope 101 and the microscope 103 is image information that has been obtained by imaging a site of a patient.

The biological information monitor 105 is a generic term representing devices that measure a plurality of pieces of biological information. The information that can be outputted from the biological information monitor 105 is ensured to be appropriately selected from various pieces of biological information that are monitored during the operation of a patient. For example, the biological information includes blood pressure, electrocardiogram, oxygen saturation, heart rate, pulse wave, brain wave, electromyogram, anesthetic depth, motor-evoked potential, and somatosensory evoked potential. The information outputted from the air conditioner 107 includes temperature, and humidity in the operating room. The information outputted from the surgical navigator 109 includes information that indicates the position of a lesion or a surgical tool inside the body or an organ of the patient. It should be noted that one device may output one type of information or a plurality of types of information.

The information storage unit 111 is able to memorize, store and read information. For example, the information storage unit 111 may be realized such as by HDD.

The image display unit 113 is a touch-screen type crystal liquid display that can display images on one screen. The image display unit 113 outputs a signal to the interface 3 in response to a user's input operation of the touch screen.

The input unit 115 has a configuration that enables user's non-contact input. For example, the input unit 115 may include a microphone that can acquire a speech sound of a user, and a speech recognition section that carries out a known speech recognition process for the speech sound acquired by the microphone to determine the content of an input. Further, for example, the input unit 115 may include a camera that picks up an image of the action (action of hands, face, head, etc.) of a user, and an action analysis section that determines the content of an input, which is correlated in advance to an action, on the basis of the action imaged by the camera.

Each of the endoscope 101, the microscope 103, the biological information monitor 105, the air conditioner 107 and the surgical navigator 109 is an example of the device. Each of the interface 3 and the application 5 is an example of the time tag inserting means (section), type tag inserting means (section), information type determining means (section), information acquiring means (section), information storing means (section), information reading means (section), information searching means (section), time zone information reading means (section), information outputting means (section), input-correlated layout setting means (section), and device operating means (section). Each of the image display unit 113 and the input unit 115 is an example of the inputting means (section).

### 2. Processes Performed by Information Integration Apparatus 1

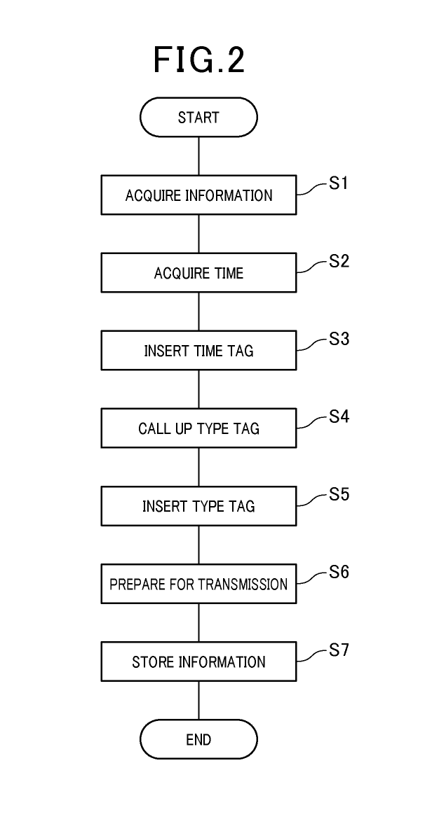

Referring to FIGS. 2 to 7, processes performed by the information integration apparatus 1 are described.

(2-1) Information Storage Process

Referring to FIG. 2, an information storage process is described. The information storage process is repeatedly performed by the information integration apparatus 1 (the providers 3B to 33 in particular) at predetermined intervals.

FIG. 2 is a flow diagram illustrating the information storage process. In step S1, the information integration apparatus 1 acquires information from the device group 117 by means of the interface 3. The information to be acquired may be of one type or of a plurality of types. Also, a plurality of types of information may be acquired from a single device.

In step S2, the information integration apparatus 1 acquires time information, which is of real time at that point, from the clock 7.

In step S3, a time tag that indicates the time acquired in step S2 is inserted in the information acquired in step S1. When a plurality of types of information are acquired in step S1, the time tag is inserted in each of the types of information.

In step S4, a type tag (that indicates type of information) stored in advance is called up. Storage of the type tag will be described later.

In step S5, the type tag called up in step S4 is inserted in the information acquired in step S1. When a plurality of types of information are acquired in step S1, the type tag is inserted in each of the types of information.

In step S6, the information integration apparatus 1 prepares for transmitting information to the information storage unit 111.

In step S7, the information integration apparatus 1 transmits the information to the information storage unit 111 by means of the interface 3 to store the information therein.

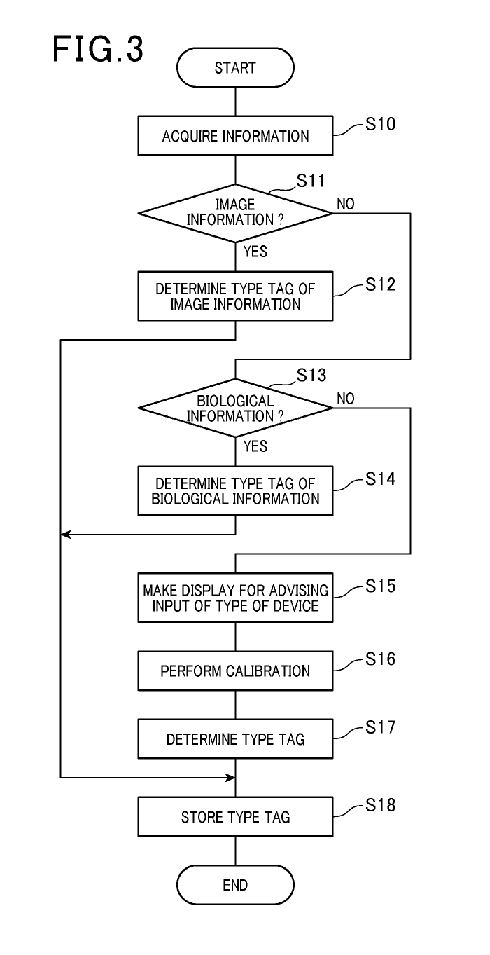

Referring to FIG. 3, hereinafter is described a process in which the information integration apparatus 1 determines and stores a type tag (information type determination process). FIG. 3 is a flow diagram illustrating the information type determination process. This process is performed upon startup or operator's operation of the information integration apparatus 1.

In step S10 of FIG. 3, similar to step 1 mentioned above, the information integration apparatus 1 acquires information from the device group 117 by means of the interface 3.

In step S11, it is determined whether or not the information acquired in step S10 is image information. If the information is image information, the control proceeds to step S12. If the information is not image information or is uncertain information, the control proceeds to step S13.

In step S12, a type tag to be inserted in the information acquired in step S10 is rendered to be a type tag of image information. After finishing the present step S12, the control proceeds to step S18.

In step S13, it is determined whether or not the information acquired in step S10 is biological information. If the information is biological information, the control proceeds to step S14. If the information is not biological information or is uncertain information, the control proceeds to step S15. The biological information includes blood pressure, electrocardiogram, oxygen saturation, heart rate, pulse wave, brain wave, electromyogram, anesthetic depth, motor-evoked potential, and somatosensory evoked potential, which are outputted from the biological information monitor 105.

For example, whether the information is biological information can be determined as follows. The value of blood pressure, electrocardiogram, oxygen saturation, heart rate, pulse wave, brain wave, electromyogram, anesthetic depth, motor-evoked potential, somatosensory evoked potential, or the like changes with time (with passage of time). The pattern of the change is unique to the type of information. Accordingly, if the information acquired in step S10 changes with time with a pattern unique to biological information, the information can be determined to be biological information. Otherwise, the information can be determined not to be biological information.

In step S14, a type tag to be inserted in the information acquired in step S10 is rendered to be a type tag of biological information. After finishing the present step S14, the control proceeds to step S18.

In step S15, the information integration apparatus 1 makes a display on the image display unit 113 to advise the user of inputting a device type of the information acquired in step S10. In response to the display, the user can make a selection of a device type of the information acquired in step S10 from options displayed on the touch screen of the image display unit 113.

In step S16, the information integration apparatus 1 performs a calibration process for determining the type of information acquired in step S10, on the basis of the user's input (selection of device type for the information acquired in step S10) in response to the display in step S15.

The calibration process is specifically described by way of an example in which the user has selected in step S15 the air conditioner 107 as a device. The air conditioner 107, which is a single device, outputs a plurality of types of information (set temperature, set humidity, airflow rate, room temperature, and humidity).

First, the information integration apparatus 1 displays the plurality of types of information on the image display unit 113. The information is displayed, for example, in the form of a graph in which the horizontal axis indicates time and the vertical axis indicates the amount of information. The information integration apparatus 1 also displays selection buttons for the respective types of information, so that a type of information can be designated.

The information integration apparatus 1 makes a display on the image display unit 113 to advise the user of changing the value of one type of information X (e.g., set temperature) with time among the five types of information. In response to the display, the user can perform a process of having the value of the information X changed with time (e.g. a process of having the set temperature of the air conditioner changed with time).

If any of the types of information has a value that changes, in response to (being highly correlated with) the user's operation, the information integration apparatus 1 determines that the type of information corresponds to the information X.

For the rest of types of information Y and Z (e.g., set humidity and airflow rate) as well, the information integration apparatus 1 makes a display, similar to the case of the information X, on the image display unit 113 to advise the user of changing the values of the information with time. If any of the types of information has a value that changes, in response to (being highly correlated with) the user's operation, the information integration apparatus 1 determines that the type of the information corresponds to the information Y or Z.

As described above, after determining the types of information X, Y and Z, if any of the five types of information has remained as being difficult to be changed with time through the user's operation (e.g., room temperature and humidity), the user can operate the selection buttons for the designation of the information.

In step S17, a type tag to be inserted in the information acquired at step S10 is determined to be the one that conforms to the type of information determined in step S16.

In step S18, the type tag that has been determined in any of steps S12, S14 and S17 is stored. The stored type tag can be called up in step 4 described above.

(2-2) Information Display Process

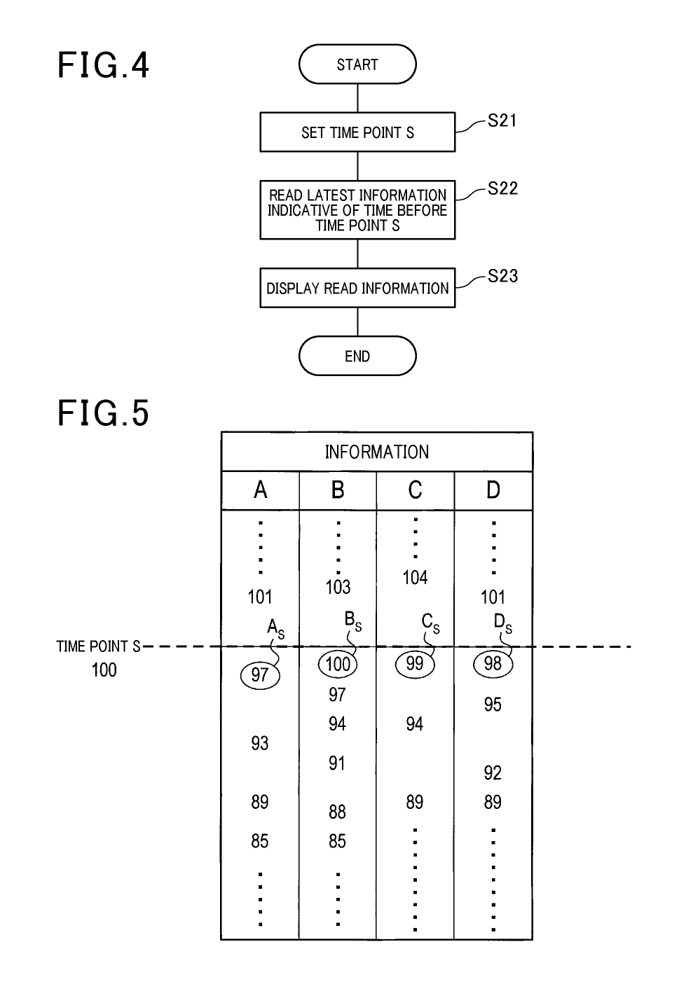

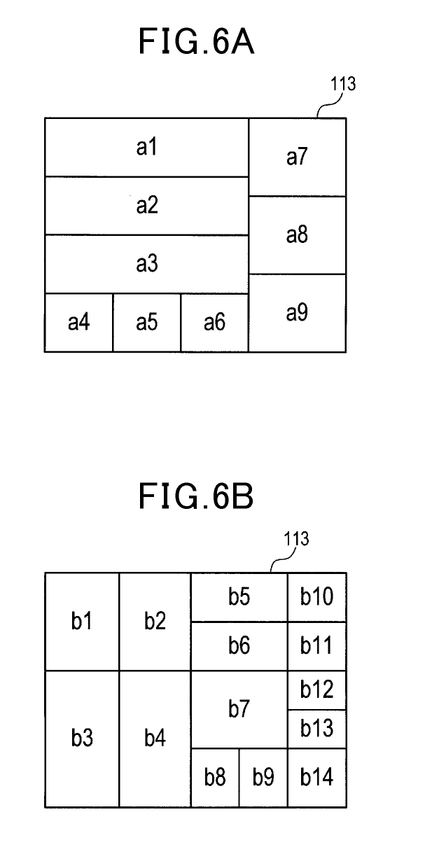

Referring to FIGS. 4 and 5 as well as FIGS. 6A and 6B, an information display process repeatedly performed by the information integration apparatus 1 (the application 5 in particular) at predetermined intervals is described.

FIG. 4 is a flow diagram illustrating the information display process. In step S21 of FIG. 4, the information integration apparatus 1 sets a time point (clock time) S which is used in step S22 described below. The time point S, for example, may be a time point earlier, by a predetermined length of time, than the real time. The time point S may be the present time (real time).

In step S22, the information integration apparatus 1 reads the information that has the latest time tag indicative of time before the time point S set in step S21, for each type of information, from the information storage unit 111. Let us take, as an example, the case where, as shown in FIG. 5, the information includes four types A to D of information, and that the time point S set in step S21 is 100 milliseconds past 9:00, (in FIG. 5, units of hr and min are omitted and “100” is indicated with a unit of msec). As shown in FIG. 5, the information of type A stored in the information storage unit 111 includes a plurality of pieces of information with the contents as shown by time tags that are indicated in a column “A” of FIG. 5. Each numeral (X) shown in FIG. 5 reads X milliseconds past 9:00.

In this case, information As having the latest time tag (97) indicative of time before the time point S in the pieces of information of type A is read from the information storage unit 111. Similarly, information Bs having the latest time tag (100) indicative of time before the time point S in the pieces of information of type B is read from the information storage unit 111. Further, information Cs having the latest time tag (99) indicative of time before the time point S in the pieces of information of type C is read from the information storage unit 111. Also, information Ds having the latest time tag (98) indicative of time before the time point S in the pieces of information of type D is read from the information storage unit 111.

Then, in step S23, the information read out in step S22 is outputted to the image display unit 113 by means of the application 5 to display the information on the image display unit 113. The information is displayed in conformity with the layout that has been set by that moment. The layout refers to a combination of the following elements.

(α) The way of dividing the display area of the image display unit 113.

(β) The types of information and the number of types of information to be concurrently displayed in each of the divided areas.

(γ) The form of display (image, numeral, graph, table, etc.) for information in each of the divided areas.

FIG. 6A shows an example of such a layout. In this example, a display area on one screen of the image display unit 113 is divided into nine areas of a1 to a9. In this layout, for example, biological information can be displayed in the areas a1, a2 and a3 in the form of a graph, and the biological information can be displayed in the areas a4 to a9 in the form of a numerical value.

FIG. 6B shows another example of such a layout. In this example, a display area on one screen of the image display unit 113 is divided into fourteen areas of b1 to b14. In this layout, for example, the image information outputted from the microscope 103 can be overlapped with an image from the surgical navigator 109, for display in the area b1 in the form of an image. Further, an image from the surgical navigator 109 can be displayed in the areas b2, b3 and b4 in the form of a trihedral figure. In addition, for example, biological information can be displayed in the areas b5 and b6 in the form of a graph. Also, image information outputted from the endoscope 101 can be displayed in the area b7 in the form of an image. In other areas, the biological information can be displayed in the form of a numerical value.

Information is displayed on a type-tag basis (by a display method suited to the type tag). For example, when the type tag of information corresponds to electrocardiogram, the information is displayed in the form of a graph in which the horizontal axis indicates time and the vertical axis indicates a value of the electrocardiogram. When the type tag of information corresponds to the information outputted from the surgical navigator 109, the information is displayed on a given coordinate in a CT (computed tomography) image. The way of display is determined by the application 5 depending on type tags.

(2-3) Layout Setting Process

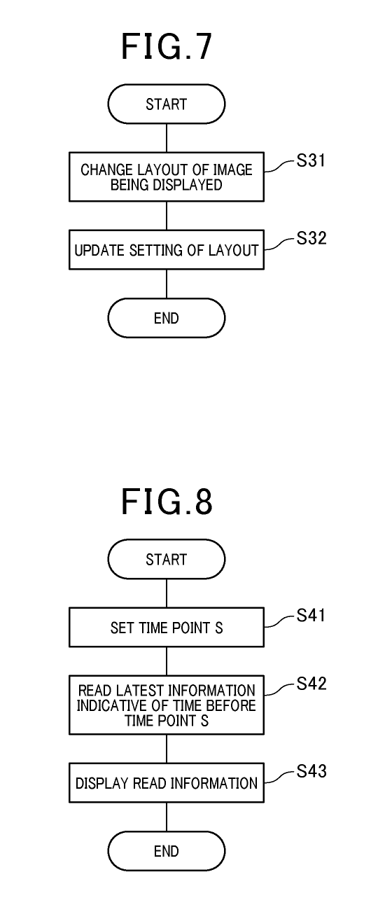

Referring to FIG. 7, a layout setting process performed by the information integration apparatus 1 (the application 5 in particular) is described. FIG. 7 is a flow diagram illustrating the layout setting process. This process is performed upon the operator's operation for instructing a change of layout on the display of the image display unit 113, from the currently used layout to a specified layout (layout instructed by the operator).

In step S31, the layout of the information displayed by the image display unit 113 is changed to the layout instructed by the operator to update the display.

In step S32, the setting of the layout is updated to that of the layout instructed by the operator. From this point onward, the layout used for display as a result of performing step 23 is the updated layout.

(2-4) Log Display

Using the input unit 115, the user is able to set two time points (clock times). Also, using the input unit 115, the user is able to select a type of information for log display. In this case, the information integration apparatus 1 reads information having a certain time tag from the information storage unit 111 and displays the read information on the image display unit 113. The certain time tag in this case has time that falls in a time zone having a start point that is one of the two set time points and an end point that is the other of the two set time points. The form of the display may be, for example, a graph or a table. Using the input unit 115, the user is able to change the form of the display (e.g., enlarge or reduce the display, or change the time zone for the display).

Using the input unit 115, the user is able to input requirements concerning information. The information integration apparatus 1 searches through the information stored in the information storage unit 111 for the information that meets the requirements and reads the time tag of the information as found.

For example, for specific biological information, the user may input a requirement of “sudden change” (e.g., requirement that a rate of change per unit time is not less than a predetermined value). In such a case, the information integration apparatus 1 searches through biological information for the information that meets the requirement and reads the time tag of the information as found.

Then, the information integration apparatus 1 reads information (type of information meeting the requirement) having a certain time tag from the information storage unit 111 and displays the information on the image display unit 113. The certain time tag in this case has time that falls in a time zone whose start or end point coincides with the time of the certain time tag, or a time zone centering on the time of the certain time tag. The form of display may be, for example, a graph or a table. Using the input unit 115, the user is able to change the form of the display (e.g., enlarge or reduce the display, or change the time zone for the display).

When the time of the time tag in the information that has been found through the search is the start point of the time zone, the end point of the time zone may be a value inputted by the user, or may be a point after a lapse of a predetermined time from the start point. When the time of the time tag in the information that has been found through the search is the end point of the time zone, the start point of the time zone may be a value inputted by the user, or may be a point before a predetermined time from the end point.

When the time of the time tag in the information that has been found through the search is the center of the time zone, the length of the time zone may be a value inputted by the user, or may be a fixed value.

(2-5) Device Operation Process

The information integration apparatus 1 detects a user's input operation (input operation performed by a user) to the touch screen of the image display unit 113. According to the contents of the input operation, any of the devices in the device group 117 is operated.

In this case, a single device or a plurality of devices may be operated. In addition to or instead of the device(s), the image display unit 113 may be operated. When the number of objects to be operated is two or more, the plurality of devices and/or the image display unit 113 (the objects to be operated) may be linked with each other and operated. For example, through a predetermined input via the touch screen of the image display unit 113, one or more objects to be operated can be selected from among a monitor 101A of the endoscope 101, the biological information monitor 105, a controller monitor 107A of the air conditioner 107, a monitor 109A of the surgical navigator 109, and the image display unit 113. In this case, the brightness and the color tone for the selected objects on the screen can be automatically adjusted to optimum conditions, taking account of visibility or eye strain.

### 3. Advantageous Effects of Information Integration Apparatus 1

(1) Upon acquisition of information from a device, the information integration apparatus 1 inserts in the information a time tag corresponding to the acquisition time and a type tag corresponding to the type of information. Then, for each type of information, the information integration apparatus 1 reads information having the latest time tag indicative of time before the time point S, from the information storage unit 111, and displays the read information on the image display unit 113. Thus, a plurality of types of information having time tags whose values (time points of acquiring information from devices) are approximate to each other can be displayed, being juxtaposed or overlapped with each other, on the image display unit 113.

(2) The information integration apparatus 1 is able to change the layout when information is displayed on the image display unit 113 according to a speech sound or an action of a user (i.e. without having the user's hand contacted the machinery).

(3) The information integration apparatus 1 is able to concurrently display a plurality of types of information on the image display unit 113.
(4) The information integration apparatus 1 is able to display information on an information-type basis (by a display method suited to the type of information) in a manner appropriate for the information.

### Second Embodiment

### 1. Configuration of Information Integration Apparatus 1

Referring to FIG. 8, a second embodiment is described. The configuration of an information integration apparatus 1 of the second embodiment is basically similar to the one described in the first embodiment. In the present embodiment, providers 3B to 33 are each provided as an example of the device type determining means (section), and an application 5 is an example of the device-type-correlated layout setting means (section).

### 2. Processes Performed by Information Integration Apparatus 1

The processes performed by the information integration apparatus 1 of the present embodiment are basically similar to those of the first embodiment, excepting that there is a partial difference in the information display process. The following description is provided focusing on the difference. FIG. 8 is a flow diagram illustrating the information display process which is repeatedly performed by the information integration apparatus 1 (the application in particular) of the present embodiment at predetermined intervals.

In step S41, a time point (clock time) S is set. The time point S is used in step 42 described below. The time point S, for example, may be a time point earlier, by a predetermined length of time, than the real time. The time point S may be the real time.

In step S42, the information integration apparatus 1 reads the information that has the latest time tag indicative of time before the time point S, for each type of information, from the information storage unit 111.

In step S43, the information integration apparatus 1 outputs the information that has been read in step S42 to the image display unit 113 by means of the application 5 and displays the information on the image display unit 113. The layout for displaying the information is determined upon startup or operator's operation of the information integration apparatus 1. A process for determining the layout is as follows.

First, the information integration apparatus 1 acquires information from a device and determines a type of device. In determining the type of device, the information integration apparatus 1 specifies the type of information through the process shown in FIG. 3 and then, based on the specified type of information, determines a corresponding type of device (which is used for acquiring the information).

Then, the information integration apparatus 1 determines a layout suitable for the type of device as determined and calls up the layout. It should be noted that the information integration apparatus 1 is provided with a map in which types of device are correlated in advance with layouts. By inputting a type of device into the map, a layout to be used is determined.

### 3. Advantageous Effects of Information Integration Apparatus 1

(1) The information integration apparatus 1 of the present embodiment can achieve the advantageous effects which are substantially the same as those of the first embodiment.

(2) The information integration apparatus 1 of the present embodiment is able to set a layout according to the type of device that has been used for acquiring the information. Thus, the information can be displayed with an appropriate layout.

### Third Embodiment

### 1. Configuration of Information Integration System 119

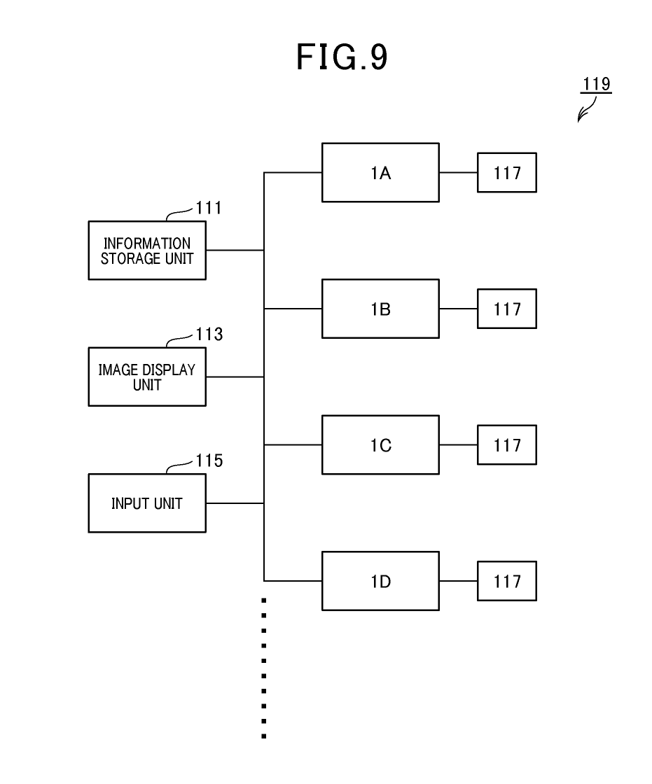

Referring to FIG. 9, the configuration of an information integration system 119 according to a third embodiment is described. FIG. 9 is a block diagram illustrating the configuration of the information integration system 119. As shown in FIG. 9, in the information integration system 119, a plurality of information integration apparatuses 1 described in the first or second embodiment are connected to each other via a network, within a range of performing a time adjustment process which will be described later. In the following description, the plurality of information integration apparatuses 1 are distinguished from each other by designating references 1A, 1B, 1C, etc thereto. The network is connected to the information storage unit 111, the image display unit 113 and the input unit 115. Each of the information integration apparatuses 1A, 1B, 1C, etc. is connected with the device group 117.

The interface 3 and the application 5 in each of the information integration apparatuses 1A, 1B, 1C, etc. are each an example of the clock adjusting means (section).

### 2. Process Performed by Information Integration System 119

Similar to the information integration apparatus 1 in the first or second embodiment, each of the information integration apparatuses 1A, 1B, 1C, etc. configuring the information integration system 119 performs the information storage process. Accordingly, the information storage unit 111 of the information integration system 119 is able to collectively store the information acquired by the plurality of information integration apparatuses 1A, 1B, 1C, etc.

Further, similar to the information integration apparatus 1 in the first or second embodiment, the information integration apparatus 1A performs the information display process, the layout setting process, and the log display process. As mentioned above, the information storage unit 111 may collectively store the information acquired by the plurality of information integration apparatuses 1A, 1B, 1C, etc. In this case, as a result of performing the information display process, the information acquired by the plurality of information integration apparatuses 1A, 1B, 1C, etc. is concurrently displayed on the image display unit 113.

The information integration system 119 performs a time adjustment process as follows. Upon every lapse of a predetermined time (e.g., every day), the information integration apparatus 1A acquires real-time (clock-time) information from its own clock 7 and transmits the time information to the rest of information integration apparatuses 1B, 1C, etc. via the network. Each of the rest of information integration apparatuses 1B, 1C, etc. adjusts the clock 7 of its own (performs a process of setting the clock) so that the time information generated by the clock 7 of its own coincides with the time information transmitted from the information integration apparatus 1A.

### 3. Advantageous Effects of Information Integration System 119

(1) The information integration system 119 can achieve the advantageous effects similar to those of the information integration apparatus 1 described in the first or second embodiment.

(2) The information integration system 119 performs the time adjustment process described above and thus is able to reduce the error between the clocks 7 of the information integration apparatuses 1A, 1B, 1C, etc. Thus, an information integration apparatus that acquires information, whichever of the information integration apparatuses 1A, 1B, 1C, etc. the apparatus may be, is able to insert a time tag of a precise time in the information to be stored in the information storage unit 111. As a result, in reading information having the latest time tag indicative of time before the time point S and in displaying the read information on the image display unit 113, the pieces of information whose actual information acquisition times are approximate to each other can be displayed, being juxtaposed.

### OTHER EMBODIMENTS

(1) In the first to third embodiments, the information storage unit 111 may be a part of the information integration apparatus 1. Further, the image display unit 113 may be a part of the information integration apparatus 1. In addition, the input unit 115 may be a part of the information integration unit 1.

(2) In the first to third embodiments, the layout may be fixed.

(3) In the first to third embodiments, a plurality of image display units 113 may be provided. In this case, a part or all of a plurality of pieces of information may be displayed in each of the image display units 113.

(4) All or a part of the configurations of the first to third embodiments may be appropriately combined.

(5) In the third embodiment, any of the information storage unit 111, the image display unit 113 and the input unit 115 may be provided to each of the information integration apparatuses 1.

It will be appreciated that the present invention is not limited to the configurations described above, but any and all modifications, variations or equivalents, which may occur to those who are skilled in the art, should be considered to fall within the scope of the present invention.

Hereinafter, aspects of the above-described embodiments will be summarized.

The information integration apparatus of the embodiment includes an information acquiring means (3B to 3F) for acquiring a plurality of pieces of information from at least one device (101, 103, 105, 107, 109); a time tag inserting means (3J) for inserting a time tag, which indicates time when the information acquiring means acquires the information, in the information; a type tag inserting means (3B to 3F) for inserting a type tag, which indicates a type of the information, in the information; an information storing means (3G) for storing the information, in which the time tag and the type tag are inserted, to an information storage unit.

In addition, the information integration apparatus of the embodiment includes an information reading means (3, 5) for setting a time point (S) and reading the information, which has the latest time tag indicative of time before the time point, for each type of the information, from the information storage unit; and an information outputting means (5) for outputting the information read by the information reading means to display the information by an image display unit using a display method suited to the type of information.

The information integration apparatus of the present invention is able to integrally display a plurality of pieces of information on the image display unit. In this case, the plurality of pieces of information have respective time tags whose values (times at which respective pieces of information have been acquired from the respective devices) are approximate to each other. In addition, the information integration apparatus can display the information on an information-type basis (by a display method suited to the type of information).

What is claimed is:

1. An information integration apparatus, comprising:
an information acquiring means for acquiring a plurality of pieces of information from at least one device;
a time tag inserting means for inserting a time tag, which indicates time when the information acquiring means acquires the information, in the information;
a type tag inserting means for inserting a type tag, which indicates a type of the information, in the information;
an information storing means for storing the information, in which the time tag and the type tag are inserted, to an information storage unit;
an information reading means for setting a time point and reading the information, which has the latest time tag indicative of time before the time point, for each type of the information, from the information storage unit; and
an information outputting means for outputting the information read by the information reading means to display the information by an image display unit using a display method suited to the type of information.

2. The information integration apparatus according to claim 1, further comprising a device type determining means for determining a type of the device from which the information acquiring means acquires the information.

3. The information integration apparatus according to claim 2, wherein
the device type determining means determines a type of the device which outputs information on the type of the acquired information.

4. The information integration apparatus according to claim 2, further comprising a device-type-correlated layout setting means for setting a layout used when the information outputted by the information outputting means is displayed by the image display unit, based on a determination result of the device type determining means.

5. The information integration apparatus according to claim 4, wherein
in the layout, the plurality of pieces of information is displayed on one screen.

6. The information integration apparatus according to claim 1, further comprising:
an inputting means to which an input operation is performed; and
a device operating means for operating the device or the image display unit according to the input operation to the inputting means.

7. The information integration apparatus according to claim 6, wherein the device operating means links and operates either two or more of the at least one device or one or more of the at least one device and the image display unit.

8. The information integration apparatus according to claim 1, further comprising an information type determining means for determining the type of the information based on change with time of the information.

9. The information integration apparatus according to claim 1, further comprising:
an information searching means for searching through the information stored in the information storage unit for the information that meets a predetermined requirement; and
a time zone information reading means for reading the information having a time tag from the information storage unit, the time tag having a time that falls in a time zone whose start or end point coincides with the time of the time tag of the searched information, or a time zone centering on the time of the time tag of the searched information, wherein
the information outputting means outputs the information read out by the time zone information reading means to display the information on the image display unit.

10. An information integration system including plural information integration apparatuses according to claim 1, wherein
each of the plural information integration apparatuses includes a clock used as a basis in setting the time point, and
the information integration system comprises a clock adjusting means for setting the clock of the plural information integration apparatuses.

11. A non-transitory computer readable recording medium in which a program is recorded to allow a computer to function as each of the means of the information integration apparatus according to claim 1.
